(19) United States
(12) Patent Application Publication
(10) Pub. No.: US 2011/0075415 A1
(43) Pub. Date: Mar. 31, 2011

(54) LED ILLUMINATION APPARATUS FOR SPOT LIGHTING

(76) Inventors: Meng Hsieh Chou, Sinjhuang City (TW); Yen Chi Wu, Sinjhuang City (TW); Chun Ping Hsu, Sinjhuang City (TW)

(21) Appl. No.: 12/634,144

(22) Filed: Dec. 9, 2009

(30) Foreign Application Priority Data
Sep. 29, 2009 (TW) 098132993

(51) Int. Cl. F21V 1/00; F21S 8/00

(52) U.S. Cl. 362/235; 362/249.02; 362/294

(57) ABSTRACT

An LED illumination apparatus for spot lighting includes a first base body, a first fixed element, a set of LED illumination module, and a second base body. The first base body has a first fixed portion. The set of first fixed element is mounted at the set of first fixed portion of the first base body, and has two relative first inclined faces. The set of LED illumination module has two light sources, which has a first end, that is fixed at the inclined faces of the first base and a second end. And second base body has a set of second fixed portion, wherein the second end of the light source is fixed at the second fixed portion.

### FIELD OF THE INVENTION

The present invention relates to an LED illumination apparatus for spot lighting, and in particular to an LED lamp capable of increasing the brightness of the LED illumination.

### DESCRIPTION OF THE RELATED ART

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected front the LED lamps onto the projecting areas. Therefore, it is an important subject for manufacturers in the related field to design an LED lamp with good directionality and even brightness.

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

### SUMMARY OF THE INVENTION

An object of the present invention is to provide an LED illumination apparatus for spot lighting capable of assembling easily to reduce the assembling cost.

An object of the present invention is to provide an LED illumination apparatus for spot lighting capable of increasing the brightness of the LED illumination.

To achieve the above-mentioned object, the present invention includes a first base body, a first fixed element, a set of LED illumination module, and a second base body. The first base body has a first fixed portion. The set of first fixed element is mounted at the set of first fixed portion of the first base body, and has two relative first inclined faces. The set of LED illumination module has two light sources, which has a first end, that is fixed at the inclined faces of the first base and a second end. And second base body has a set of second fixed portion, wherein the second end of the light source is fixed at the second fixed portion.

### BRIEF DESCRIPTION OF THE DRAWINGS

FIG. 1 is an exploded view of an LED lamp with spot light of the present invention.

FIG. 2 is a parts assembly drawing of the FIG. 2

FIG. 3A is a cross-sectional view of the first base body of first preferred embodiment.

FIG. 3B is a cross-sectional view of the first base body second preferred embodiment.

FIG. 4 is a cross-sectional view of the LED illumination module of the FIG. 1.

FIG. 5 is an exploded view of an LED lamp with shades of the present invention.

FIG. 6A is a cross-sectional view of the second base body of first preferred embodiment.

FIG. 6B is a cross-sectional view of the second base body of second preferred embodiment.

FIG. 7 is assembly drawing of the FIG. 5.

### DETAILED DESCRIPTION OF THE INVENTION

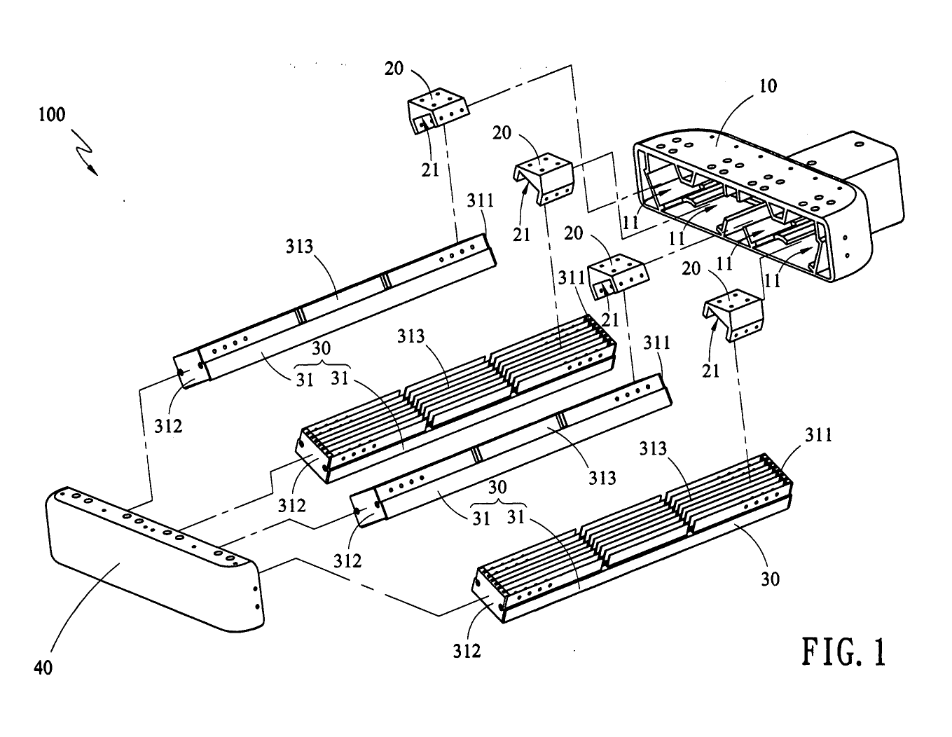

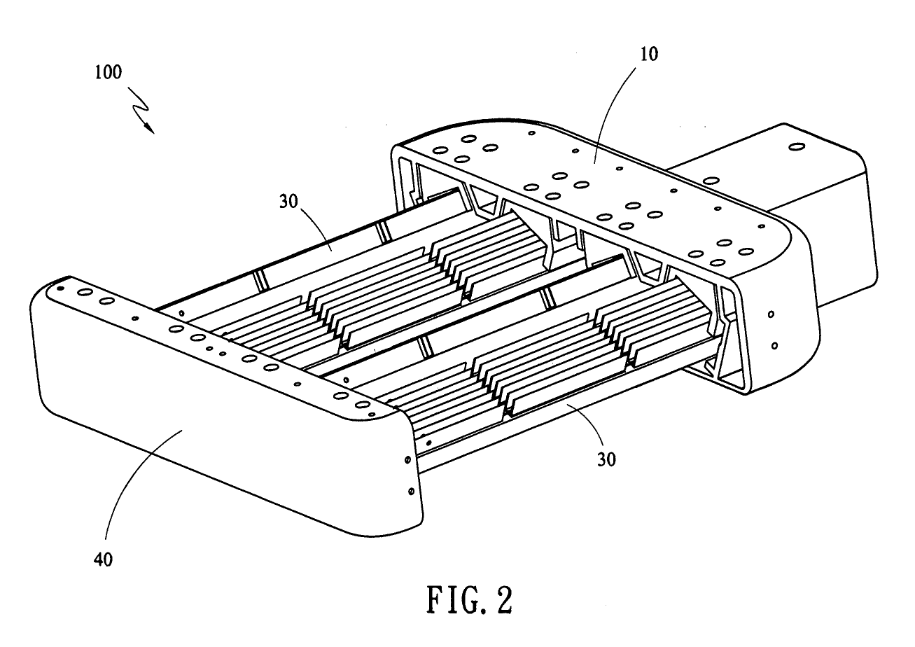

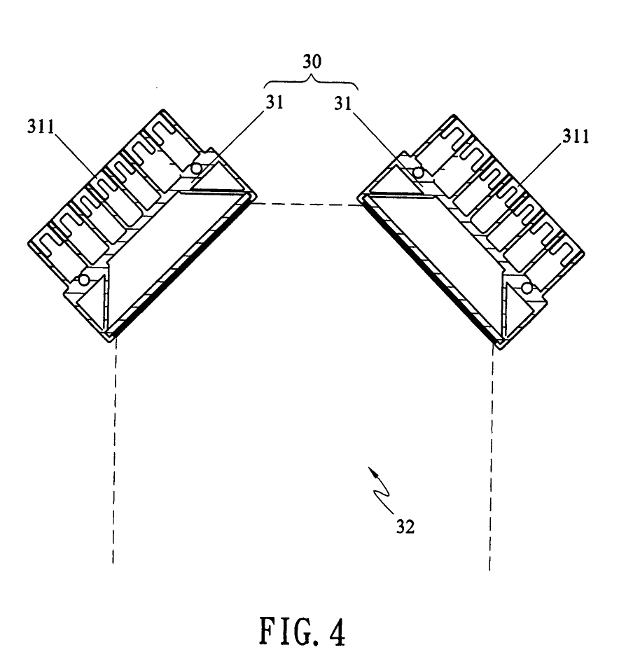

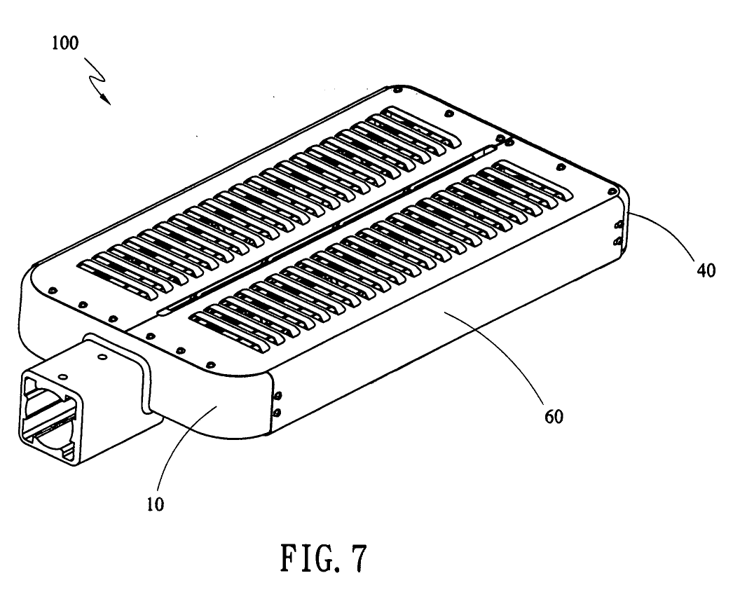

Referring to FIG. 1-FIG. 7, an LED illumination apparatus 100 for spot lighting of the present invention includes a first base body 10, two set of first fixed element 20, a set of LED illumination module 30, a second base body 40, two set second fixed element 50 and a set of shade 60.

The first base body 10 has two set of first fixed portion 11.

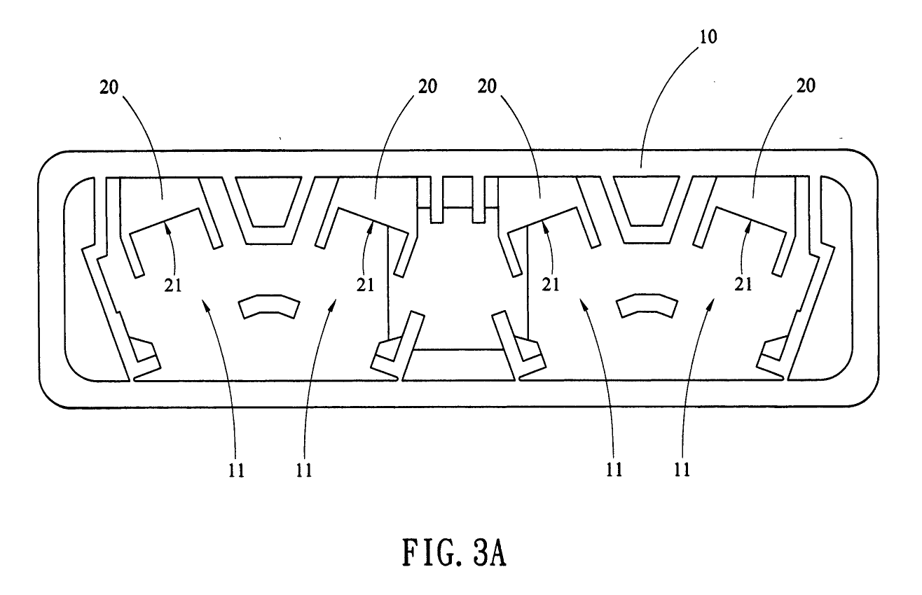

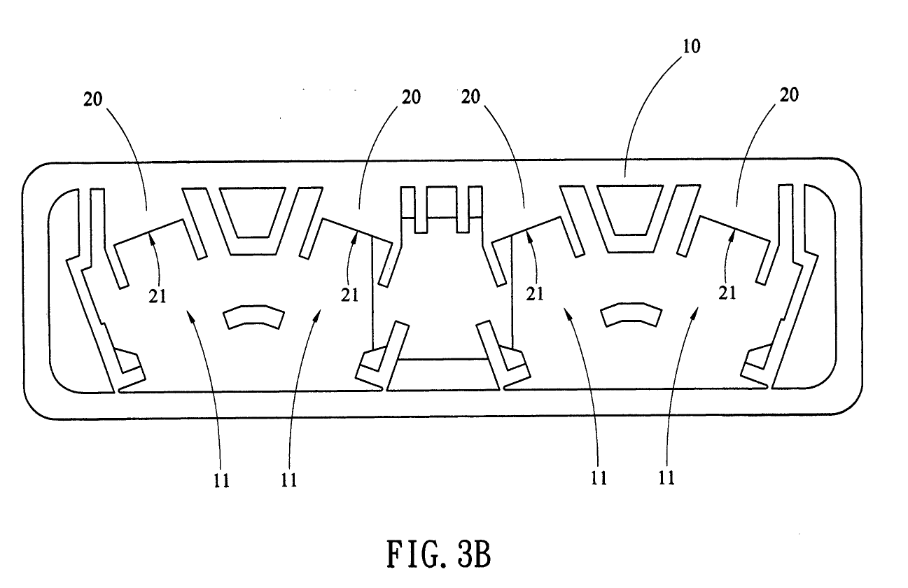

The two first fixed elements 20 are mounted at correspond to the first fixed portion 11 of the first base body 10, wherein the two first fixed elements 20 have two relative first inclined faces 21. Please referring to FIG. 3B, the first fixed element 11 and the first base body 10 are integrally.

The LED illumination module 30 has two light sources 31, which has first end 311 mounted at the inclined surfaces 21 and second end 312, and the light sources 31 is formed with heat sink sheet 313.

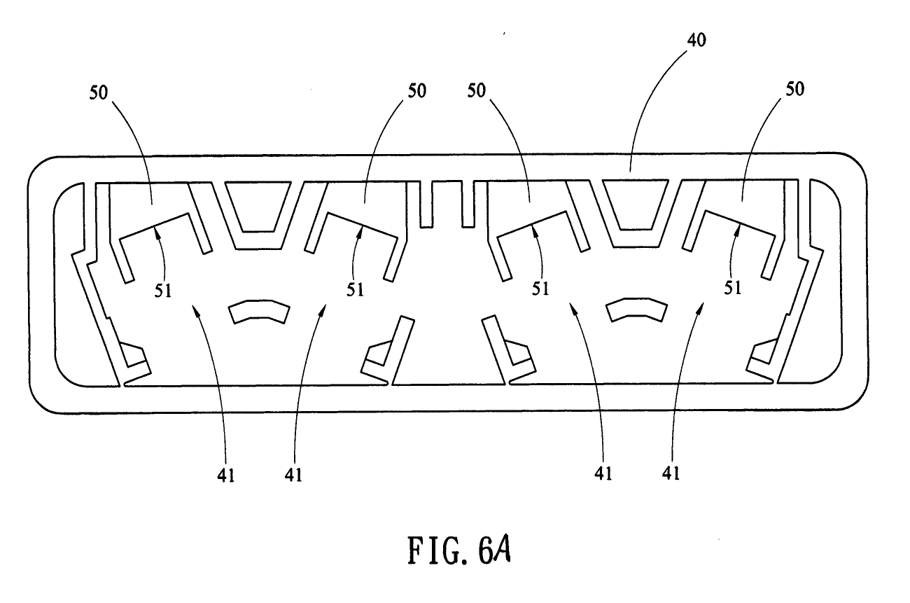

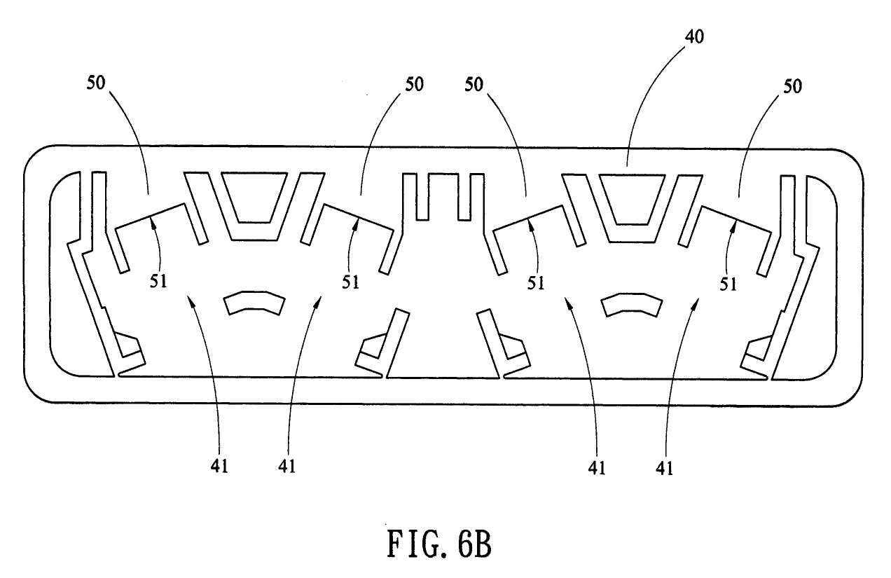

The second base body 40 has two set of second fixed portion 41, as shown in FIG. 6A. The second end 312 of the light source 31 is fixed at the second fixed portion 41 of the second base body 40.

The two set of second fixed element 50 are mounted at the second fixed portion of the second base body 40, and has two relative second inclined faces 51, as shown in FIG. 6A, wherein the second end 312 of the tight sources 31 is fixed at the second inclined faces 51 of the second base body 40. Please referring to FIG. 6B, the second fixed element 50 and the second base body 40 are integrally. And

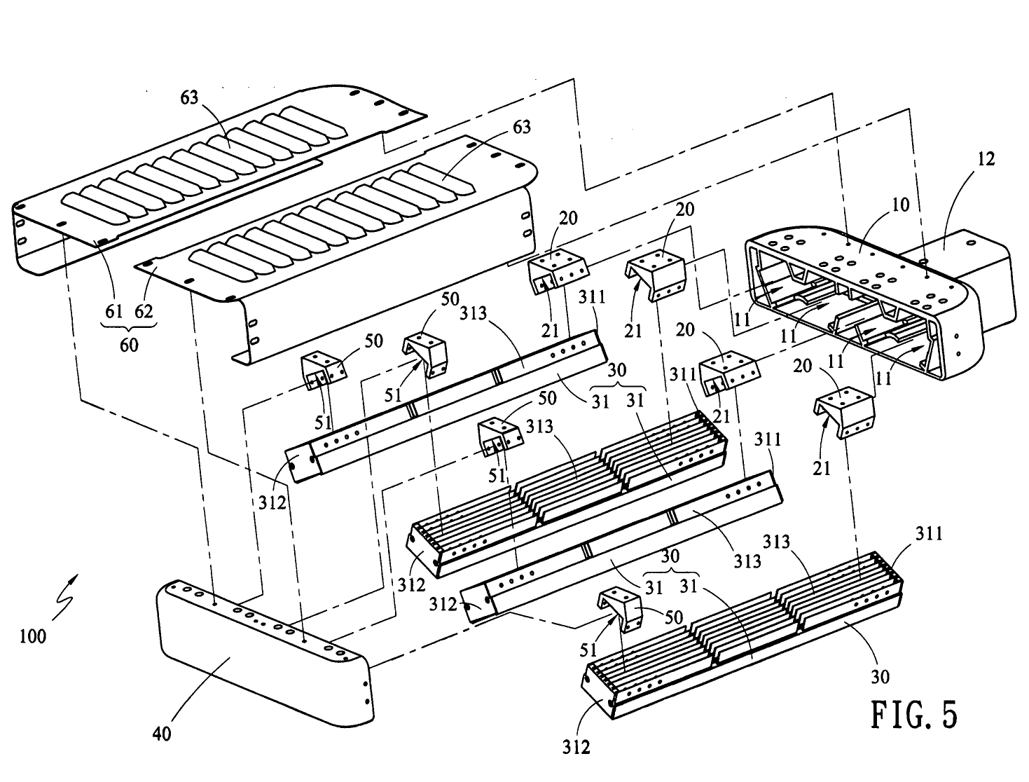

The shade 60 is arranged between the first base body 10 and the second base body 40 for covering the LED illumination module 30. The shade 60 is formed with heat dissipation holes 63 and has a left shade 61 and a right shade 62, as shown in FIG. 5.

Therefore, according to the above-mentioned structure, after the LED lamp has been assembled, and the LED illumination module may spot lighting through the inclined faces 21 of the first fixed element 20.

While the present has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED illumination apparatus for spot lighting comprising:
A first base body with at least a set of first fixed portion;
At least a set of first fixed element mounted at the set of first fixed portion of the first base body and having two relative first inclined faces;
At least a set of LED illumination module, each module with two light sources, each light source having a first end, which is fixed at the inclined faces of the first base and a second end; and
A second base body with at least a set of second fixed portion, wherein the second end of the light source is fixed at the second fixed portion.

2. The LED illumination apparatus for spot lighting according to claim 1, wherein the first base body and the first fixed element are integrally.

3. The LED illumination apparatus for spot lighting according to claim 1, further comprising at least a set of second fixed element is fixed at the second fixed portion of the second base body and having two relative second inclined faces, wherein the second end of the light sources is fixed at the second inclined faces of the second base body.

4. The LED illumination apparatus for spot lighting according to claim 3, wherein the second fixed element and the second base body are integrally.

5. The LED illumination apparatus for spot lighting according to claim 1, further comprising a set of shade, which is located between first base body and second base body to cover the LED illumination module.

6. The LED illumination apparatus for spot lighting according to claim 1, wherein the shade is formed with heat dissipation holes.

7. The LED illumination apparatus for spot lighting according to claim 1, wherein the LED illumination module is formed with heat sink sheets.
